(19) United States
(12) Patent Application Publication
(10) Pub. No.: US 2007/0097329 A1
(43) Pub. Date: May 3, 2007

(54) REAR PROJECTION SYSTEM

(76) Inventors: Ming-Tsung Ho, Taipei Hsien (TW); Kuo-Yen Lai, Hsin-Chu Hsien (TW); Chia-Lin Liu, Tai-Chung Hsien (TW); Chi-Neng Mo, Tao-Yuan Hsien (TW); Shih-Min Wu, I-Lan Hsien (TW)

Correspondence Address: NORTH AMERICA INTELLECTUAL PROPERTY CORPORATION, P.O. BOX 506, MERRIFIELD, VA, 22116, US

(21) Appl. No.: 11/163,713

(22) Filed: Oct. 27, 2005

(51) Int. Cl. G03B 21/28; G03B 21/22

(52) U.S. Cl. 353/77

(57) ABSTRACT

A rear projection system includes a partially transmissive reflector, an image source installed on one side of the reflector for projecting an image to the reflector, a screen for receiving the image projected from the image source and reflected from the reflector so as to display the image, at least one light sensor installed on the other side of the reflector for sensing light of the image projected from the image source to the reflector and passing through the reflector, and a control module coupled to the light sensor for controlling the image source to project a next image according to the sensing result of the light sensor.

### BACKGROUND OF THE INVENTION

1. Field of the Invention

The present invention relates to a rear projection system capable of adjusting an output image according to a sensing result of a light sensor, and more particularly, to a rear projection system capable of adjusting an output image according to a sensing result of a light sensor positioned behind a reflector.

2. Description of the Prior Art

Increasing demand for large screen televisions is giving rise to an expanding market for planar televisions. Advanced technologies overcome the obstacles of manufacturing large-scale planar displays and gradually lower the prices of the products. Therefore, large-scale planar displays, once appearing as expensive professional equipment, have found an increasing number of household applications, such as in home theaters. Various projection techniques aiming at providing better visual experience are constantly being researched and developed. Among them, rear projection displays feature high contrast, high brightness, large viewing angles, sharp picture definition and low geometrical distortion, and are therefore very competitive in the market.

Please refer to FIG. 1 and FIG. 2. FIG. 1 is a perspective drawing of a rear projection system 10 of the prior art, and FIG. 2 is a diagram of internal components of the rear projection system 10. The rear projection system 10 can be a cathode ray tube (CRT) monitor, a digital light processing (DLP) monitor, a liquid crystal on silicon (LCOS) monitor, or a liquid crystal display (LCD) monitor, depending on the kind of image source. The rear projection system 10 includes a housing 12 for covering internal components, a reflector 14 installed inside the housing 12, an image source 16 installed inside the housing 12 and positioned on one side of the reflector 14 for projecting an image to the reflector 14, a screen 18 installed on the housing 12 for receiving the image projected from the image source 16 to the reflector 14 and reflected from the reflector 14 so as to display the image, and a plurality of light sensors 20 installed on the housing 12 and around the screen 18 for sensing light reflected from the reflector 14. The image source 16 can be a source with a single light source or multiple light sources. The image source 16 can project an image to the reflector 14, and the reflector 14 can reflect the image projected from the image source 16 to the screen 18 so that the image can be presented on the screen 18.

If the image source 16 includes multiple light sources, such as three cathode ray tubes, there is a need to detect or adjust the image focused on the screen 18. The light sensors 20 positioned around the screen 18 can sense light projected around the screen 18, and the rear projection system 10 can detect the focus status of the image according to the sensing result of the light sensors 20 so as to adjust the image. The advantage of positioning the light sensors 20 around the screen 18 is to prevent the light sensors 20 from blocking light projected to the screen 18. However, the disadvantage of positioning the light sensors 20 around the screen 18 is that the light sensors 20 can only detect the focus status of the light surrounding the screen 18 and cannot detect the focus status of the entire image on the screen 18. Hence the light sensors 20 are useless for detecting the focus status of the image on the screen 18 despite the number of light sensors positioned around the screen 18.

### SUMMARY OF THE INVENTION

It is therefore a primary objective of the claimed invention to provide a rear projection system capable of adjusting an output image according to a sensing result of a light sensor positioned behind a reflector for solving the above-mentioned problem.

According to claimed invention, a rear projection system includes a partially transmissive reflector with light-transmissivity, an image source installed on one side of the reflector for projecting an image to the reflector, a screen for receiving the image projected from the image source and reflected from the reflector so as to display the image, at least one light sensor installed on the other side of the reflector for sensing light of the image projected from the image source to the reflector and passing through the reflector, and a control module coupled to the light sensor for controlling the image source to project a next image according to the sensing result of the light sensor.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a perspective drawing of a rear projection system in the prior art.

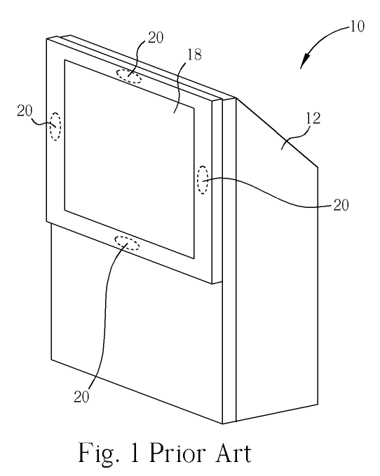

FIG. 2 is a diagram of internal components of the rear projection system of FIG. 1.

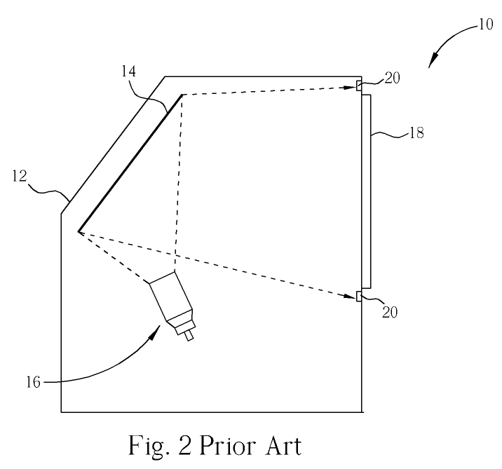

FIG. 3 is a perspective drawing of a rear projection system according to the present invention.

FIG. 4 is a diagram of internal components of the rear projection system of FIG. 3.

FIG. 5 is a functional block diagram of the rear projection system of FIG. 3.

### DETAILED DESCRIPTION

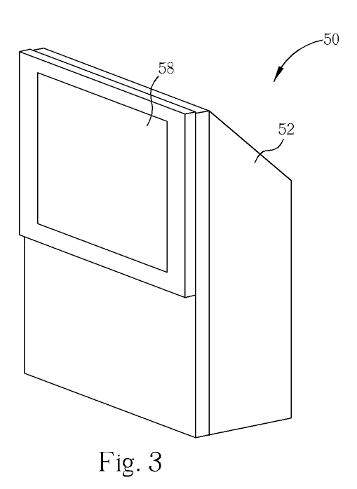

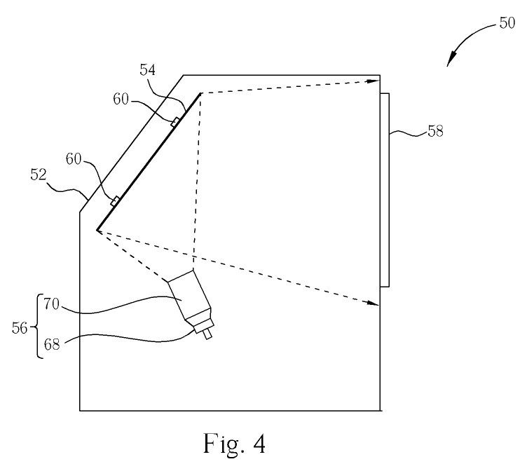

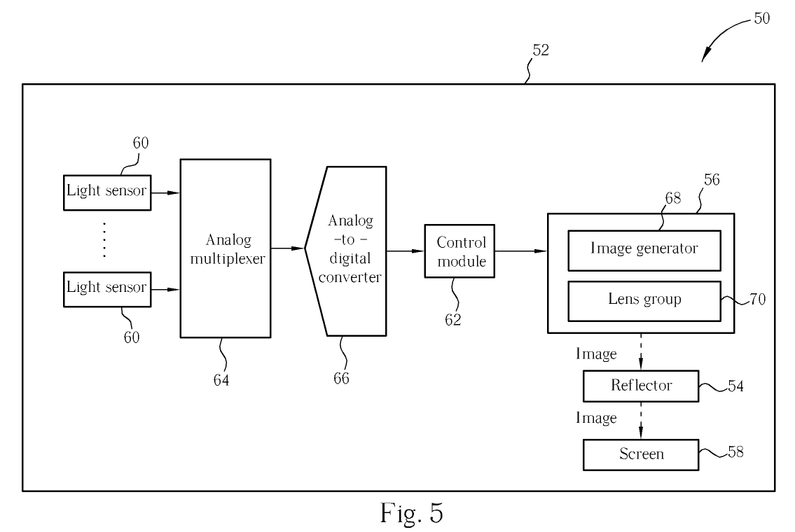

Please refer to FIG. 3, FIG. 4, and FIG. 5. FIG. 3 is a perspective drawing of a rear projection system 50 according to the present invention, FIG. 4 is a diagram of internal components of the rear projection system 50 according to the present invention, and FIG. 5 is a functional block diagram of the rear projection system 50 according to the present invention. The rear projection system 50 can be a cathode ray tube (CRT) monitor, a digital light processing (DLP) monitor, a liquid crystal on silicon (LCOS) monitor, or a liquid crystal display (LCD) monitor, depending on the kind of image source. The rear projection system 50 includes a housing 52 for covering internal components, a partially transmissive reflector 54 installed inside the housing 52, an image source 56 installed inside the housing 52 and positioned on one side of the reflector 54 for projecting an image to the reflector 54, and a screen 58 installed on the housing 52 for receiving the image projected from the image source 56 to the reflector 54 and reflected from the reflector 54 so as to display the image. The screen 58 can be a rectangular screen. The rear projection system 50 further includes at least one light sensor 60 installed on the other side of the reflector 54 for sensing the light of the image projected from the image source 56 to the reflector 54 and passing through the reflector 54. The light sensor 60 can be a photoelectric sensor. As shown in FIG. 5, the rear projection system 50 includes a control module 62 for controlling the image source 56 to project a next image (i.e. the next frame in a TV show or movie) according to the sensing result of the light sensors 60, an analog multiplexer 64 for receiving data of light detection generated by the light sensors 60, an analog-to-digital converter 66 for converting the data from the analog multiplexer 64 into digital data and transferring the digital data to the control module 62.

Additionally, the image source 56 is positioned between the reflector 54 and the screen 58. The image source 56 can have a single light source or multiple light sources. The image source 56 includes an image generator 68 for transforming an image signal from the control module 62 into a corresponding image, and a lens group 70 for receiving and adjusting the image generated by the image generator 68 and projecting the adjusted image to the reflector 54. The image source 56 can project an image to the reflector 54, and the reflector 54 can reflect the image projected from the image source 56 to the screen 58 so that the image can be presented on the screen 58.

The detailed operation is described as follows. First, the control module 62 outputs an image signal to the image generator 68 so the image generator 68 can transform the image signal into a corresponding image. Afterward, the lens group 70 receives the image generated by the image generator 68, then to adjust the image and projects the adjusted image to the reflector 54. The reflector 54 can reflect the image projected from the image source 56 to the screen 58 so that the image can be presented on the screen 58. When the image is projected to the reflector 54, the light sensors 60 can sense the light of the image projected from the image source 56 and passing through the reflector 54 due to the partial light-transmissivity of the reflector 54 and the position of the light sensors 60 on the other side of the reflector 54. When the light sensors 60 sense different amounts of light passing through the reflector 54, the light sensors 60 can output different voltages to the analog multiplexer 64, depending on the color of the light, the brightness of the light, the illuminated area on the light sensor 60, and so on. The analog multiplexer 64 transfers the data from the light sensors 60 to the analog-to-digital converter 66. The analog-to-digital converter 66 converts the data from the analog multiplexer 64 into digital data and transfers the digital data to the control module 62. After the control module 62 receives the digital data transmitted from the analog-to-digital converter 66, the control module 62 examines the focus status of the image projected by the image source 56, such as by determining whether the brightness of the light is low or whether the white balance of the light is biased, and adjusts the next image appropriately so as to control the image source 56 to project the next image according to the sensing result of the light sensors 60. The control module 62 can adjust the lens group 70 so as to adjust the size and the position of the image according to the sensing result of the light sensors 60 or to adjust the brightness of the image generated by the image generator 68 according to the sensing result of the light sensors 60.

Furthermore, since the incident angle of the light emitted from the image source 56 to the reflector 54 is equal to the reflected angle of the light reflected from the reflector 54, the position on the reflector 54 to which the image source 56 projects the image corresponds to the position on the screen 58 to which the reflector 54 reflects the image. That is, the position of the image that a viewer sees on the screen 58 corresponds to the position on the reflector 54 corresponding with the locations of the light sensors 60 installed on the other side of the reflector 54. Therefore the sensing result at the position of each light sensor 60 can represent the detection result at the corresponding position of the image on the screen 58.

The quantity and the location of the light sensors 60 according to the present invention depends on the design demand. For example, more light sensors positioned at different locations on the other side of the reflector 54 corresponding to locations on the screen 58 can increase the precision of focus detection in the rear projection system 50. However, there is a trade-off between precision and increased cost of installing extra light sensors.

In conclusion, because the light sensors 60 are installed behind the reflector 54, the light sensors 60 can detect the focus status of the entire image, such as whether the brightness of the image source 56 is low or whether the white balance of the light is biased, without blocking or obstructing the light projected to the screen 58. Furthermore, since the reflector 54 is positioned in front of the light sensors 60 the reflector 54 can filter most stray light so that the detection quality of the light sensors 60 is improved.

In contrast to the rear projection system of the prior art, the rear projection system according to the present invention can detect the focus status of the entire image without affecting the light projected onto the screen. The present invention can overcome the disadvantages of positioning the light sensors around the screen.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A rear projection system comprising:
a partially transmissive reflector;
an image source installed on one side of the reflector for projecting an image to the reflector;
a screen for receiving the image projected from the image source to the reflector and reflected from the reflector so as to display the image;
at least one light sensor installed on the other side of the reflector for sensing light of the image projected from the image source to the reflector and passing through the reflector; and
a control module coupled to the light sensor for controlling the image source to project a next image according to the sensing result of the light sensor.

2. The rear projection system of claim 1 wherein the image source is installed between the reflector and the screen.

3. The rear projection system of claim 1 wherein the image source comprises:
an image generator for transforming an image signal into a corresponding image; and
a lens group for receiving and adjusting the image generated by the image generator and projecting the adjusted image to the reflector.

4. The rear projection system of claim 3 wherein the control module is capable of adjusting the lens group so as to adjust the size and the position of the image according to the sensing result of the light sensor.

5. The rear projection system of claim 3 wherein the control module is capable of adjusting the brightness of the image generated by the image generator according to the sensing result of the light sensor.

6. The rear projection system of claim 1 wherein the screen is a rectangular screen.

7. The rear projection system of claim 1 further comprising an analog multiplexer for receiving light detection data generated by the light sensor.

8. The rear projection system of claim 7 further comprising an analog-to-digital converter for converting the data from the analog multiplexer into digital data and transferring the digital data to the control module.

9. The rear projection system of claim 1 further comprising an analog-to-digital converter for converting data from the light sensor into digital data and transferring the digital data to the control module.

10. The rear projection system of claim 1 being a cathode ray tube (CRT) monitor.

11. The rear projection system of claim 1 being a digital light processing (DLP) monitor.

12. The rear projection system of claim 1 being a liquid crystal on silicon (LOS) monitor.

13. The rear projection system of claim 1 being a liquid crystal display (LCD) monitor.
